(19) United States
(12) Patent Application Publication
(10) Pub. No.: US 2017/0294927 A1
(43) Pub. Date: Oct. 12, 2017

(54) INTERFERENCE STATE DETECTION METHOD AND DEVICE

(71) Applicant: ZTE Corporation, Shenzhen, Guangdong (CN)

(72) Inventor: Bing Xue, Shenzhen (CN)

(21) Appl. No.: 15/507,287

(22) PCT Filed: Feb. 28, 2015
(86) PCT No.: PCT/CN2015/073417

§ 371 Date: Feb. 28, 2017

(30) Foreign Application Priority Data
Sep. 2, 2014 (CN) 201410443893.7

(51) Int. Cl. H04B 1/10

(52) U.S. Cl. CPC H04B 1/1027; H04W 28/048

(57) ABSTRACT

The disclosure discloses an interference state detection method and device. The method includes that: a silence parameter is transmitted to all terminals in a communication system; when the communication system is in a silence state, a silence communication parameter of a base station is acquired; the silence communication parameter is compared with a standard communication parameter of the base station; and an interference state of the communication system is determined according to a comparison result.

### TECHNICAL FIELD

The disclosure relates to the field of communication networks, and more particularly to an interference state detection method and device for a communication system.

### BACKGROUND

Interference of a communication system may cause influence on using experiences of a user. In a related technology, for ensuring the using experiences of the user, a technician is required to monitor background communication data in real time to judge whether interference exists in the communication system or not, and in case of existence of interference in the system, the technician is required to carry testing equipment to each failure site for troubleshooting, and then may perform positioning analysis by combining a background network management system. Such an interference monitoring and elimination mechanism is very poor in efficiency. For example, in case of existence of interference in the communication system, base stations are required to be troubleshot one by one, which may cause great manpower and material resource waste.

Therefore, how to provide a method capable of fast analysing an interference state in a communication system is a technical problem urgent to be solved by those skilled in the art.

### SUMMARY

Embodiments of the disclosure provide an interference state detection method and device, which may detect, analyse and alarm a communication system quickly.

An interference state detection method may include: a silence parameter is transmitted to all terminals in a communication system formed by the terminals and a base station; when the communication system is in a silence state, a silence communication parameter of the base station is acquired; the silence communication parameter is compared with a standard communication parameter of the base station; and an interference state of the communication system is determined according to a comparison result.

In an exemplary embodiment, the method may further include that: when interference exists in the communication system, an interference source type is determined, wherein the step that the interference source type is determined may include that: a master silence communication parameter and diversity silence communication parameter of a signal received by the base station are acquired, and are compared with the standard communication parameter respectively, the interference source type is determined to be component intermodulation of the base station if the master silence communication parameter is larger than the standard communication parameter and the diversity silence communication parameter is normal, and the interference source type is determined to be external interference of the communication system if the master silence communication parameter and the diversity silence communication parameter are both larger than the standard communication parameter.

Optionally, the silence communication parameter of the base station may be real-time signal strength of the signal received by the base station in a reverse link when the communication system is in the silence state; and the standard communication parameter of the base station may be standard signal strength, calculated according to a standard noise floor of the communication system, of the signal received by the base station.

In an exemplary embodiment, the step that the silence parameter is transmitted to all the terminals in the communication system may include that: the silence parameter is periodically transmitted to all the terminals in the communication system; and the method may further include that: the interference state of the communication system in a silence period is acquired, and a network environment of the communication system is analysed and determined.

In an exemplary embodiment, the step that the silence parameter is transmitted to all the terminals in the communication system formed by the terminals and the base station may be replaced with that: a real-time communication parameter of the base station is acquired in real time during normal communication of the communication system; when the real-time communication parameter is larger than an alarm threshold value, the silence parameter is transmitted to all the terminals in the communication system; and the method may further include that: an alarm is given according to the interference state.

In an exemplary embodiment, the step that the alarm is given according to the interference state may include that: the alarm is given indicating that the interference exists in the communication system if the interference state indicates that the interference exists in the communication system, and the alarm is given indicating that transmitted power of the terminals in the communication system is excessively high if the interference state indicates that no interference exists in the communication system.

In an exemplary embodiment, the method may further include that: the communication system is detected according to the alarm.

An interference state detection device may include: a transmission module, arranged to transmit a silence parameter to all terminals in a communication system formed by the terminals and a base station; an acquisition module, arranged to acquire, when the communication system is in a silence state, a silence communication parameter of the base station; a comparison module, arranged to compare the silence communication parameter with a standard communication parameter of the base station; and a determination module, arranged to determine an interference state of the communication system according to a comparison result.

In an exemplary embodiment, the transmission module may be arranged to periodically transmit the silence parameter to all the terminals in the communication system; and the device may further include: a comprehensive analysis module, arranged to acquire the interference state of the communication system in a silence period, and analyse and determine a network environment of the communication system.

In an exemplary embodiment, the device may further include: a real-time detection module, arranged to acquire a real-time communication parameter of the base station in real time during normal communication of the communication system; and an alarm module, arranged to give an alarm according to the interference state, wherein the transmission module may be arranged to transmit, when the real-time communication parameter is larger than an alarm threshold value, the silence parameter to all the terminals in the communication system.

The embodiments of the disclosure further provide a computer-readable storage medium, which may store program instructions, when being executed, to implement the abovementioned method.

According to the detection, analysis and alarm method and device provided by the embodiments of the disclosure, the communication system is kept in the silence state to avoid influence of signals sent by the terminals on the signal strength of the signal received by the base station at first, and the silence communication parameter is compared with the standard communication parameter to determine whether the interference exists in the communication system or not, so that whether the interference exists in the system or not may be determined quickly and a prompt may be given, and therefore the problems of high workload, low speed and the like caused by one-by-one manual detection of parameters such as a state of the base station in the related technology are solved. In addition, according to the solution of detecting the interference state on the basis of a silence mechanism in the embodiments of the disclosure, whether the network environment is healthy or not may also be periodically analysed, and an alarm reason may also be displayed when the alarm is given for the communication system, so that a worker may pertinently perform troubleshooting, and working efficiency is improved.

### BRIEF DESCRIPTION OF THE DRAWINGS

FIG. 1 is a flowchart of a detection method according to a first embodiment of the disclosure;

FIG. 2 is a structure diagram of a detection device according to a second embodiment of the disclosure; and

FIG. 3 is a flowchart of an alarm method according to a third embodiment of the disclosure.

### DETAILED DESCRIPTION

The disclosure will now be further explained and described with reference to specific implementation modes and the drawings.

### First Embodiment

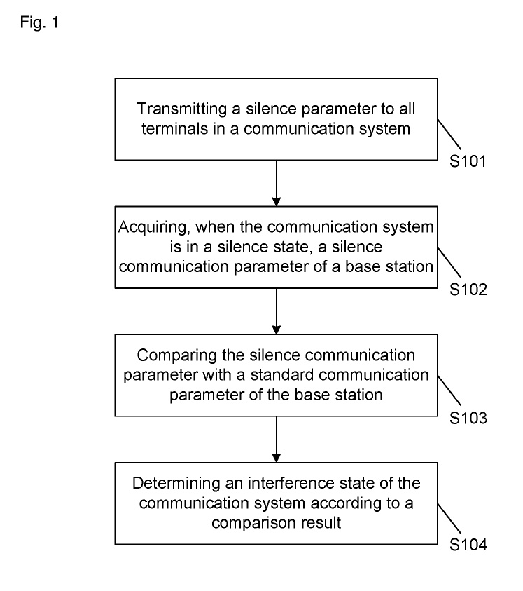

FIG. 1 is a flowchart of a detection method according to a first embodiment of the disclosure. As shown in FIG. 1, the detection method for a communication system in the embodiment includes the following steps.

At S101: a silence parameter is transmitted to all terminals in the communication system.

A base station transmits the silence parameter including a reverse link silence starting time, a silence duration, a silence period and the like to the terminals through a sector parameter message, and the terminals may stop sending data on reverse links after receiving these silence parameters. Therefore, communication parameters such as signal strength of output signals detected by the base station on the reverse links may not be influenced by input signals, and may be only related to interference existing in the system.

At S102: when the communication system is in a silence state, a silence communication parameter of a base station is acquired.

After the terminals stop sending the data on the reverse links, the base station calculates current communication parameters such as the signal strength of the output signals, i.e. silence communication parameters.

At S103: the silence communication parameter is compared with a standard communication parameter of the base station.

At S104: an interference state of the communication system is determined according to a comparison result.

The communication parameters involved in the embodiment may include all parameters in a fixed changing relationship with interference strength and input signal strength, such as the signal strength of the output signals. Specifically, in the silence state of the communication system, there are no signals sent by the terminals in the reverse links, so that the communication parameters of the signals received by the base station are only related to noise (environmental noise and the like) in a network, equipment interference (interference generated by intermodulation of a feeder line or other passive device) and interference of other signal (such as a military signal). In order to facilitate measurement and comparison, the communication parameter may be a signal strength value which is easy to measure, and the disclosure will also be described below with the condition that the communication parameter is a Received Signal Strength Indication (RSSI) as an example.

In some embodiments, the silence communication parameter of the base station is real-time signal strength of a signal received by the base station in a reverse link when the communication system is in the silence state; and the standard communication parameter of the base station is standard signal strength, calculated according to a standard noise floor of the communication system, of the signal received by the base station. For the RSSI, an implementation principle of judging whether interference exists in the communication system or not according to the RSSI is that: the RSSI (which is a strength value of a signal received by a receiver in a communication network) refers to signal strength of a signal received by a receiver circuit (which mainly refers to a system base station) in a communication system on a reverse link; and output power Pout, input power Pin, noise factor NF and gain G on a base station side meet the following relationship:

Pₒᵤₜ=(dBm)=10*lg(10^{(-174 dBm/Hz+10*lgB(Hz)30 NF(dB))/10}+10^{Pin(dBm)/10})+G(dB).

For simplifying description, it is defined that there is only power input by noise of the nature when a communication bandwidth of a certain communication system is B:

−174 dBm/Hz+10*lgB(Hz)=TN(dBm),

and

it is substituted into the above relational expression to obtain:

Pₒᵤₜ=Pᵢₙ+G+10*lg(1+10^{((TN+NF)-P}^{ᵢₙ}^{)/10})dBm

or

Pₒᵤₜ=(TN+NF)+G+10*lg(1+10^{(P}^{ᵢₙ}^{-(TN+NF))/10})dBm.

For a specific system, B is specific, so that it is considered that B is a known quantity and corresponding TN is also a known quantity during analysis for the specific system. Then, when the communication system is in the silence state, there is no uplink signal (the input power Pin is a fixed value) in the system, and when environmental noise is fixed in the communication system (the environmental noise is a fixed value, and is usually −174 dBm/Hz), the RSSI of the output signal (related to the output power Pout) is also a fixed value. That is, for a system with fixed input power Pin, a detected RSSI is also fixed, and if interference exists in the system, the RSSI may be increased. Therefore, for a system with an RSSI function, when a silence RSSI detected in the silence state of the system is larger than a standard RSSI calculated according to the above relationship, it is indicated that interference exists in the system.

In some embodiments, Step S104 in the embodiment includes that: the interference exists in the communication system if the comparison result is that the silence communication parameter is larger than the standard communication parameter, and the interference does not exist in the communication system if the comparison result is that the silence communication parameter is equal to the standard communication parameter.

In some embodiments, when the result in Step S104 indicates that the interference exists in the communication system, the method further includes a step that an interference source type is determined. The step that the interference source type is determined includes that: a master silence communication parameter and diversity silence communication parameter of the signal received by the base station are acquired, and are compared with the standard communication parameter respectively, the interference source type is determined to be component intermodulation of the base station if the master silence communication parameter is larger than the standard communication parameter and the diversity silence communication parameter is normal, and the interference source type is determined to be external interference of the communication system if the master silence communication parameter and the diversity silence communication parameter are both larger than the standard communication parameter. Specifically, the base station receives signals through a master and at least one diversity. In the embodiment, the interference source type may be determined according to the comparison result of the master silence communication parameter and the diversity silence communication parameter with the standard communication parameter. For example, the interference source type is determined to be component intermodulation of the base station (mainly including interference caused by a failure of equipment of the base station, such as interference caused by intermodulation of the feeder line or other passive device) if the master silence communication parameter is larger than the standard communication parameter and the diversity silence communication parameter is normal, and the interference source type is determined to be external interference of the communication system (mainly including interference of an external environment, such as interference of the military signal) if the master silence communication parameter and the diversity silence communication parameter are both larger than the standard communication parameter.

The embodiment shown in FIG. 1 may be adopted to detect, after a new base station is arranged, whether equipment of the base station is correctly mounted or not and the like, may also be adopted to detect whether other strong interference signal exists around the base station or not and the like, and may be mainly adopted to display an alarm reason to a worker, when an alarm about a high RSSI of the communication system is given, for the worker to pertinently perform detection and further fast implement troubleshooting, and may further be adopted to periodically make analytic statistics about whether a network environment is healthy or not.

### Second Embodiment

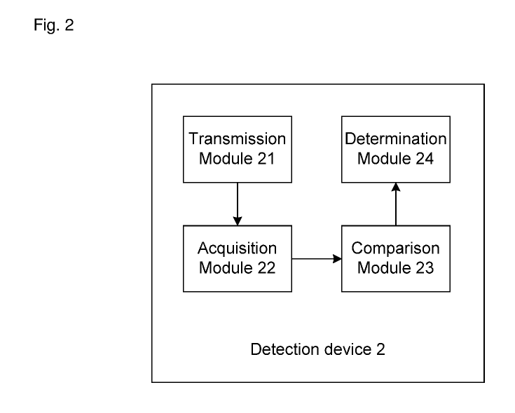

FIG. 2 is a structure diagram of a detection device according to a second embodiment of the disclosure. As shown in FIG. 2, the detection device 2 provided by the disclosure in the embodiment includes the following function modules: a transmission module 21, arranged to transmit a silence parameter to all terminals in a communication system; an acquisition module 22, arranged to acquire, when the communication system is in a silence state, a silence communication parameter of a base station; a comparison module 23, arranged to compare the silence communication parameter with a standard communication parameter of the base station; and a determination module 24, arranged to determine an interference state of the communication system according to a comparison result.

In some embodiments, when interference exists in the communication system, the determination module 24 in the detection device 2 shown in FIG. 2 is further arranged to determine an interference source type, and in an exemplary embodiment is arranged to acquire and compare a master silence communication parameter and diversity silence communication parameter of a signal received by the base station with the standard communication parameter respectively, determine that the interference source type is component intermodulation of the base station if the master silence communication parameter is larger than the standard communication parameter and the diversity silence communication parameter is normal, and determine that the interference source type is external interference of the communication system if the master silence communication parameter and the diversity silence communication parameter are both larger than the standard communication parameter.

Wherein, the transmission module may be arranged to periodically transmit the silence parameter to all the terminals in the communication system; and the device may further include: a comprehensive analysis module, arranged to acquire the interference state of the communication system in a silence period, and analyse and determine a network environment of the communication system.

The device may further include: a real-time detection module, arranged to acquire a real-time communication parameter of the base station in real time during normal communication of the communication system; and an alarm module, arranged to give an alarm according to the interference state, wherein the transmission module is arranged to transmit, when the real-time communication parameter is larger than an alarm threshold value, the silence parameter to all the terminals in the communication system.

The disclosure further provides an analysis method and device and an alarm method and device to adopt the detection method provided by the disclosure, specifically as follows.

The analysis method provided by the disclosure is adopted to analyse a network environment of a communication system formed by terminals and a base station. In some embodiments, the analysis method includes the following steps that: a silence parameter is periodically transmitted to all the terminals in the communication system; when the communication system is in a silence state, a silence communication parameter of the base station is acquired, the silence communication parameter is compared with a standard communication parameter of the base station, an interference state of the communication system is determined according to a comparison result, and the interference state of the communication system is acquired; and the interference state of the communication system in a silence period is acquired, and a network environment of the communication system is analysed and determined.

Correspondingly, the analysis device provided by the disclosure is arranged to analyse a network environment of a communication system formed by terminals and a base station. In some embodiments, the analysis device includes: a silence triggering module, arranged to periodically transmit a silence parameter to all the terminals in the communication system; an interference detection module, arranged to acquire, when the communication system is in a silence state, a silence communication parameter of the base station, compare the silence communication parameter with a standard communication parameter of the base station, determine an interference state of the communication system according to a comparison result, and acquire the interference state of the communication system; and a comprehensive analysis module, arranged to acquire the interference state of the communication system in a silence period, and analyse and determine a network environment of the communication system.

The system may work normally without influence in the silence period, so the whole communication system may be kept in the silence period all the time. That is, according to the analysis method and device provided by the disclosure, the whole wireless network environment is analysed in batches by virtue of a tool for daily wireless environment analysis and maintenance, and if interference exists in the communication system all the time during analysis in a certain period of time, it is indicated that the system is unhealthy, and a worker is required to eliminate the interference.

The alarm method provided by the disclosure is adopted to give an alarm for a communication system formed by terminals and a base station. In some embodiments, the alarm method includes the following steps that: a real-time communication parameter of the base station is acquired in real time during normal communication of the communication system; when the real-time communication parameter is larger than an alarm threshold value, a silence parameter is transmitted to all the terminals in the communication system, and when the communication system is in a silence state, a silence communication parameter of the base station is acquired, the silence communication parameter is compared with a standard communication parameter of the base station, an interference state of the communication system is determined according to a comparison result, and the interference state of the communication system is acquired; and an alarm is given according to the interference state.

In the related technology, when the real-time communication parameter is larger than the alarm threshold value, an alarm is directly given, but the worker does not know about an alarm reason, so troubleshooting is non-pertinent. While in the embodiment, when a certain communication parameter of the communication system is larger than the alarm threshold value, reason elimination is performed to judge whether it is caused by interference or not by virtue of a silence mechanism at first, so that the worker may know about the alarm reason when seeing the alarm, and may further perform pertinent troubleshooting.

In some embodiments, the step that the alarm is given according to the interference state in the embodiment includes that: an alarm is given indicating that interference exists in the communication system if the interference state indicates that the interference exists in the communication system, and the alarm is given indicating that transmitted power of the terminals in the communication system is excessively high if the interference state indicates that no interference exists in the communication system.

In some embodiments, the embodiment further includes that: the communication system is detected according to the alarm.

Correspondingly, the alarm device provided by the disclosure is arranged to give an alarm for a communication system formed by terminals and a base station. In some embodiments, the alarm device includes: a real-time detection module, arranged to acquire a real-time communication parameter of the base station in real time during normal communication of the communication system; an alarm analysis module, arranged to transmit, when the real-time communication parameter is larger than an alarm threshold value, a silence parameter to all the terminals in the communication system, and acquire, when the communication system is in a silence state, a silence communication parameter of the base station, compare the silence communication parameter with a standard communication parameter of the base station, determine an interference state of the communication system according to a comparison result, and acquire the interference state of the communication system; and an alarm module, arranged to give an alarm according to the interference state.

The embodiment of the disclosure will now be explained and described with a specific application example.

### Third Embodiment

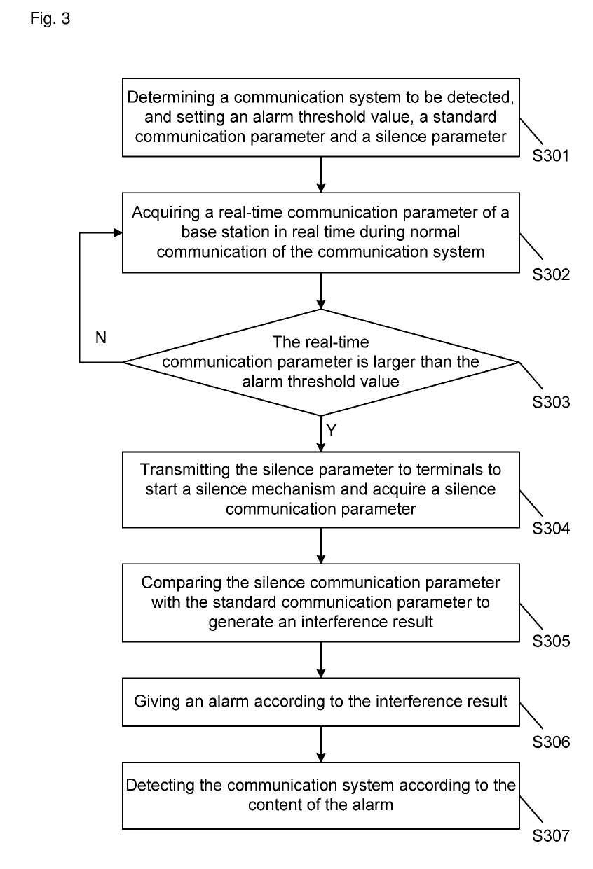

In the embodiment, the disclosure is further explained and described with the condition that a communication parameter is signal strength and a high alarm is given for a communication system as an example. FIG. 3 is a flowchart of an alarm method according to a third embodiment of the disclosure. As shown in FIG. 3, the alarm method provided by the disclosure in the embodiment includes the following steps.

At S301: a communication system to be detected is determined, and an alarm threshold value, a standard communication parameter and a silence parameter are set.

In an exemplary embodiment, the step includes that: the alarm threshold value is set according to communication capacity of the communication system, for example, the alarm threshold value is set to be Th=−80 dBm; input power, gain factor and communication bandwidth of the system are acquired, and standard signal strength of the system is calculated according to Pₒᵤₜ=Pᵢₙ+G+10*lg(1+10^{((TN+NF)-P}^{ᵢₙ}^{)/10})dBm, for example, the standard signal strength is set to be a standard RSSI=−107 dBm; and the silence parameter includes three parameters, i.e. a reverse link silence starting time, a silence duration and a silence period, and for sending time of a part of reverse service channels occupied by reverse link silence, the worst condition is considered: when the silence duration is 3 frames and the silence period is 437 s, reverse link silence occupies about 0.15% of system time resources, and may be neglected. Specifically, for example, for a Code Division Multiple Access (CDMA) system, a reverse link silence starting time T (system time with a frame as a unit) meets a relational expression T mod (2048×2ReverseLinkSilencePeriod1)=0, a silence duration ReverseLinkSilenceDuration is usually set to be 0-3 frames, and a silence period ReverseLinkSilencePeriod may be selected from 54 s (2,025 frames), 109 s (4,050 frames), 218 s (8,100 frames) and 437 s (16,200 frames).

At S302: a real-time communication parameter of a base station is acquired in real time during normal communication of the communication system.

In an exemplary embodiment, real-time signal strength of a signal received by the base station is acquired in real time, and is recorded as a real-time RSSI.

At S303: the real-time communication parameter is compared with the alarm threshold value to judge whether the real-time communication parameter is larger than the alarm threshold value or not, Step S304 is executed if YES, and if NO, Step S302 is executed.

For example, when the real-time RSSI=−100 dBm and the real-time RSSI<Th, Step S302 is executed; and when the real-time RSSI=−60 dBm and the real-time RSSI>Th, Step S304 is executed.

At S304: the silence parameter is transmitted to terminals to start a silence mechanism, and a silence communication parameter is acquired.

The base station, by adding the silence parameter such as the silence starting time, the silence duration and the silence period of the reverse link into a sector parameter message, sends the silence parameter to the terminals. The terminals stop sending data on the reverse service channels immediately after receiving these parameters, and the silence mechanism is started. The base station calculates an RSSI value provided by a radio frequency control module in this period of time, and marks it as a silence RSSI value.

At S305: the silence communication parameter is compared with the standard communication parameter to generate an interference result.

If the silence communication parameter is the silence RSSI=−110 dBm, the silence RSSI<a standard RSSI, then the interference result is that no interference exists; and if the silence communication parameter is the silence RSSI=−100 dBm, the silence RSSI>the standard RSSI, then the interference result is that interference exists.

When the interference result is that the interference exists, an interference source type may further be determined by comparing a master silence RSSI and a diversity silence RSSI with the standard RSSI respectively. The interference source type is determined to be component intermodulation of the base station if the master silence RSSI is larger than the standard RSSI and the diversity silence RSSI is normal, and the interference source type is determined to be external interference of the communication system if the master silence RSSI and the diversity silence RSSI are both larger than the standard RSSI.

At S306: an alarm is given according to the interference result.

If the interference state is that the interference exists in the communication system, the content of the alarm is that the interference exists in the communication system, and the interference source type may also be displayed; and if the interference state is that no interference exists in the communication system, the content of the alarm is that transmitted power of the terminals in the communication system is excessively high.

At S307: the communication system is detected according to the content of the alarm.

Wherein, when the content of the alarm is that the interference exists and the interference source type is component intermodulation of the base station, it is judged whether to start an intermodulation detection mechanism to locate whether the high RSSI is caused by intermodulation of a feeder line or other passive device. A worker may fast handle with a failure according to a detection result.

When the content of the alarm is that the interference exists and the interference source type is the external interference of the system, a spectrum scanning mechanism is started to draw amplitudes and frequency points of the interference. Spectrum scanning is to reflect a spectrum of a signal received within a reverse receiving frequency band range and draw spectrum graphics in an Operation and Maintenance Centre (OMC) by virtue of a spectrum scanning module. The interference source type may be analysed by virtue of a spectrum characteristic. Spectrum acquisition is triggered once by an acquisition instruction of a spectrum scanning Central Processing Unit (CPU), a frame of spectrum of a carrier of a master or a diversity is acquired every time, a frame of spectrum consists of 128 pieces of data, a reporting period is tunable, and spectrum graphics is drawn from the data in a background by virtue of Fast Fourier Transform (FFT). According to an obtained parameter such as a frequency point and amplitude of an interference signal, the worker may determine a source of the interference signal and adopt a corresponding solution.

When the content of the alarm is that the transmitted power of the terminals in the communication system is excessively high, a network analysis mechanism is started, and whether a wireless parameter such as a neighbouring cell, a power control parameter and an access parameter is reasonably configured or not is detected.

To sum up, the embodiments of the disclosure at least have the following beneficial effects.

The communication system is kept in the silence state to avoid influence of signals sent by the terminals on the signal strength of the signal received by the base station at first, and the silence communication parameter is compared with the standard communication parameter to determine whether the interference exists in the communication system or not, so that whether the interference exists in the system or not may be fast determined and a prompt may be given, and the problems of high workload, low speed and the like caused by one-by-one manual detection of parameters such as a state of the base station in the related technology are solved; and

In addition, according to the solution of detecting the interference state on the basis of a silence mechanism in the embodiments of the disclosure, whether the network environment is healthy or not may also be periodically analysed, and an alarm reason may also be displayed when the alarm is given for the communication system, so that a worker may pertinently perform troubleshooting, and working efficiency is improved.

The above description is only the specific implementation mode of the disclosure and not intended to limit the disclosure in any form.

Those skilled in the art should know that all or part of the steps of the abovementioned embodiments may be implemented by a flow of a computer program which may be stored in a computer-readable storage medium. The computer program is executed on a corresponding hardware platform (such as a system, equipment, a device and an apparatus), and during execution, one or combinations of the steps of the method embodiment are included.

Alternatively, all or part of the steps of the abovementioned embodiments may also be implemented by virtue of an integrated circuit. These steps may be made as individual integrated circuit modules respectively, or a plurality of modules or steps therein may be made as a single integrated circuit module for implementation. Therefore, the disclosure is not limited to any specific hardware and software combination.

Each device/function module/function unit in the abovementioned embodiments may be implemented by adopting a general purpose computing device, and they may be concentrated on a single computing device, and may also be distributed on a network formed by a plurality of computing devices.

When being implemented in form of software function module and sold or used as an independent product, each device/function module/function unit in the abovementioned embodiments may be stored in a computer-readable storage medium. The abovementioned computer-readable storage medium may be a read-only memory, a magnetic disk, an optical disk or the like.

### INDUSTRIAL APPLICABILITY

By the embodiments of the disclosure, the problems of high workload, low speed and the like caused by one-by-one manual detection of the parameters such as the state of the base station in the related technology are solved.

1. An interference state detection method, comprising:
transmitting a silence parameter to all terminals in a communication system formed by the terminals and a base station;
acquiring, when the communication system is in a silence state, a silence communication parameter of the base station;
comparing the silence communication parameter with a standard communication parameter of the base station; and
determining an interference state of the communication system according to a comparison result.

2. The method according to claim 1, further comprising: determining, when interference exists in the communication system, an interference source type, wherein the step of determining the interference source type comprises: acquiring a master silence communication parameter and diversity silence communication parameter of a signal received by the base station and comparing the master silence communication parameter and the diversity silence communication parameter with the standard communication parameter respectively, determining that the interference source type is component intermodulation of the base station if the master silence communication parameter is larger than the standard communication parameter and the diversity silence communication parameter is normal, and determining that the interference source type is external interference of the communication system if the master silence communication parameter and the diversity silence communication parameter are both larger than the standard communication parameter.

3. The method according to claim 1, wherein the silence communication parameter of the base station is real-time signal strength of the signal received by the base station in a reverse link when the communication system is in the silence state; and the standard communication parameter of the base station is standard signal strength, calculated according to a standard noise floor of the communication system, of the signal received by the base station.

4. The method according to claim 1, wherein
the step of transmitting the silence parameter to all the terminals in the communication system comprises: periodically transmitting the silence parameter to all the terminals in the communication system; and
the method further comprises: acquiring the interference state of the communication system in a silence period, and analysing and determining a network environment of the communication system.

5. The method according to claim 1, wherein
the step of transmitting the silence parameter to all the terminals in the communication system formed by the terminals and the base station is replaced with:
acquiring a real-time communication parameter of the base station in real time during normal communication of the communication system;
transmitting, when the real-time communication parameter is larger than an alarm threshold value, the silence parameter to all the terminals in the communication system; and
the method further comprises: giving an alarm according to the interference state.

6. The method according to claim 5, wherein the step of giving the alarm according to the interference state comprises: giving the alarm indicating that the interference exists in the communication system if the interference state indicates that the interference exists in the communication system, and giving the alarm indicating that transmitted power of the terminals in the communication system is excessively high if the interference state indicates that no interference exists in the communication system.

7. The method according to claim 5, further comprising:
detecting the communication system according to the alarm.

8. An interference state detection device, comprising a processor and a memory for storing instructions executable by the processor, wherein the processor is arranged to:
transmit a silence parameter to all terminals in a communication system formed by the terminals and a base station;
acquire, when the communication system is in a silence state, a silence communication parameter of the base station;
compare the silence communication parameter with a standard communication parameter of the base station; and
determine an interference state of the communication system according to a comparison result.

9. The device according to claim 8, wherein the processor is further arranged to:
periodically transmit the silence parameter to all the terminals in the communication system; and
acquire the interference state of the communication system in a silence period, and analyse and determine a network environment of the communication system.

10. The device according to claim 9, wherein the processor is further arranged to:
acquire a real-time communication parameter of the base station in real time during normal communication of the communication system;
give an alarm according to the interference state, and
transmit, when the real-time communication parameter is larger than an alarm threshold value, the silence parameter to all the terminals in the communication system.

11. A non-transient computer-readable storage medium storing program instructions when executed to implement:
transmitting a silence parameter to all terminals in a communication system formed by the terminals and a base station;
acquiring, when the communication system is in a silence state, a silence communication parameter of the base station;
comparing the silence communication parameter with a standard communication parameter of the base station; and
determining an interference state of the communication system according to a comparison result.

12. The method according to claim 2, wherein the silence communication parameter of the base station is real-time signal strength of the signal received by the base station in a reverse link when the communication system is in the silence state; and the standard communication parameter of the base station is standard signal strength, calculated according to a standard noise floor of the communication system, of the signal received by the base station.

13. The method according to claim 6, further comprising: detecting the communication system according to the alarm.

14. The device according to claim 8, wherein when interference exists in the communication system, the processor is further arranged to: acquire a master silence communication parameter and diversity silence communication parameter of a signal received by the base station and compare the master silence communication parameter and the diversity silence communication parameter with the standard communication parameter respectively, determine that an interference source type is component intermodulation of the base station if the master silence communication parameter is larger than the standard communication parameter and the diversity silence communication parameter is normal, and determine that the interference source type is external interference of the communication system if the master silence communication parameter and the diversity silence communication parameter are both larger than the standard communication parameter.

15. The device according to claim 8, wherein the silence communication parameter of the base station is real-time signal strength of the signal received by the base station in a reverse link when the communication system is in the silence state; and the standard communication parameter of the base station is standard signal strength, calculated according to a standard noise floor of the communication system, of the signal received by the base station.

16. The device according to claim 10, wherein the processor is further arranged to: give the alarm indicating that the interference exists in the communication system if the interference state indicates that the interference exists in the communication system, and give the alarm indicating that transmitted power of the terminals in the communication system is excessively high if the interference state indicates that no interference exists in the communication system.

17. The device according to claim 10, wherein the processor is further arranged to: detect the communication system according to the alarm.

18. The device according to claim 14, wherein the silence communication parameter of the base station is real-time signal strength of the signal received by the base station in a reverse link when the communication system is in the silence state; and the standard communication parameter of the base station is standard signal strength, calculated according to a standard noise floor of the communication system, of the signal received by the base station.

19. The device according to claim 16, wherein the processor is further arranged to: detect the communication system according to the alarm.
